(19) United States
(12) Patent Application Publication
(10) Pub. No.: US 2007/0079880 A1
(43) Pub. Date: Apr. 12, 2007

(54) Flush adapter

(76) Inventors: Karl-Johan Westin, Santa Margarita, CA (US); Michael C. Gagne, Mission Viejo, CA (US)

Correspondence Address: Maria Erlinda C. Sarno, Esq., P. O. Box 1023, Artesia, CA, 90702, US

(21) Appl. No.: 11/246,321

(22) Filed: Oct. 7, 2005

(51) Int. Cl. F16L 41/00

(52) U.S. Cl. 137/561 A

(57) ABSTRACT

A flush adapter, comprising an elongated spout having a bent tip on one end and a channel on the other end, the channel enclosed within a wider enclosed outlet with an opening outside of the channel. An example of a method for displacing fluids and particles from a non-readily accessible area using the flush adapter to prevent fluid stagnation and particle deposition, comprises: inserting the flush adapter into the non-readily accessible area; positioning the bent tip of the elongated spout to face the direction of the fluid flow along the main stream; continuously diverting a portion of the fluid flow downwards into the non-readily accessible area at a rate sufficient to displace the fluid inside the non-readily accessible area; and, exiting the displaced fluid through the opening on the enclosed outlet into the fluid flowing along the main stream.

This invention relates to a flush adapter for preventing stagnant fluid and settling of particles in non-readily accessible areas like the dead legs present in a fluid transport or delivery system.

### BACKGROUND

Dead legs have always posed problems of differing nature. Dead legs herein mean areas or sections in a fluid path or conduit through which fluids do not flow or are not readily accessible. Consequently, dead legs have provided a place where fluids can be stagnant and act as sites for harboring foreign materials, particles, residues, suspended solids and bacterial contaminants. Dead legs are particularly a problem in relation to food, drug and biochemical processing. For example, particles collecting within a dead leg will flush out in a concentrated form when an outlet port connected to a dead leg such as a tee fitting directed vertically downwards from a main fluid path is opened. This will result in a more concentrated particles into the collected fluid or if used as a sampling port for testing, will provide an inaccurate result or a non-representative sample. Unwanted particles present in a dead leg can come from sediments, scales, deposits, biofilms, etc. residing or deposited along the inner walls of pipes or conduits used in a fluid transport system. There are so many known means of transporting fluids and they will all be referred to herein as conduit. Constant or periodic bleeding of fluids from the dead legs will help the situation but this approach can be very costly especially for fluids such as biochemical drugs which are not only expensive but may be available only in very limited amounts.

Industries have proposed guidelines or regulations on the maximum dead leg that can be tolerated in a process system. A dead leg is generally defined in this context as a dead end length of pipe of greater than five pipe diameters in length, that is dead legs are measured by the term L/D where L is the extension from the inside diameter (ID) wall normal to the flow pattern or direction and D is the internal diameter of the extension or leg of a tubing or the nominal dimensions of a valve or instrument. The tolerable L/D ratio is usually dictated by the industry or the technology. For example, high-purity water and clean steam systems operate with an L/D ratio of 2:1.

Additionally, dead legs have made it difficult for a fluid transport system to be cleaned in place (CIP) or steamed in place (SIP).

It is therefore an object of this invention to provide a device that would continually flush fluids within a non-readily accessible area like a dead leg to prevent stagnation of fluids or deposition of particles and the like.

It is also an object of this invention to provide a dead leg flush adapter that can meet an industry standard.

It is a further object of this invention to provide a flush adapter that will allow a fluid transport system to be cleaned or steamed in place.

### SUMMARY OF THE INVENTION

This invention relates to a flush adapter for accessing fluids in non-readily accessible areas like a dead leg. The flush adapter comprises an elongated spout having a bent tip on one end and a channel on the other end, the channel enclosed within a wider enclosed outlet with the enclosed outlet having an opening outside of the channel and means for connecting the flush adapter to non-readily accessible area like the dead leg and another means for connecting the flush adapter to a device. The enclosed outlet is of differing height or length depending upon the application and the type of connector used for attaching the flush adapter. The height is less than the length of the non-readily accessible area such as the length of a dead leg. The enclosed outlet can be a thick plate usually having a thickness of less than two inches. The elongated spout is an open or a closed arcuate spout. The end of the elongated spout opposite the bent tip may be made to protrude beyond the channel enclosed within the enclosed outlet. For some connecting means, the enclosed outlet may be enveloped inside a single gasket having a central opening exposing the elongated spout extending from the channel and the opening of the enclosed outlet. The tip of the elongated spout is recommended to be bent smoothly and at an angle that will not create any pockets or dead ends along a fluid path. The flush adapter is either permanently or not permanently connected to the non-readily accessible area like the dead leg and to other devices. The flush adapter can also have a combination of permanent and non-permanent connections. Examples of permanent connections are welding and permanent bonding of the flush adapter to the respective connecting points. There are also so many known non-permanent connections that can be used to attach the flush adapter to the dead leg for example and to other devices. This provide the flexibility of removing or replacing the flush adapter from its point of application. Non-permanent connectors can be sanitary or non-sanitary depending upon the needs of the industry utilizing the adapter. Ferrules are commonly used in sanitary industries like the Pharmaceutical, Biochemical and Semiconductor industries. For ferrule connectors, the elongated spout attaches to a platform of the ferrule connector with the bent tip facing away from the opening of the enclosed outlet. The elongated spout can also attach to an enclosed outlet having a groove on a top and a bottom surface, the top groove accommodating a gasket from a first ferrule and the bottom groove accommodating another gasket from a second ferrule that matches with the first ferrule. One set of ferrules or a plurality of matching ferrules can be used depending upon the type of connections desired.

A method for displacing fluids and particles from a non-readily accessible area with a flush adapter described above having an open or closed elongated spout with a bent tip on one end, held by an enclosed outlet having an opening outside of the elongated spout, comprises:

a) inserting the flush adapter into the non-readily accessible area;

b) protruding the bent tip of the flush adapter above an inner wall of a conduit connected to the non-readily accessible area;

c) positioning the bent tip to face the direction of the fluid flow ;

d) continuously diverting a portion of the fluid flow downwards into the non-readily accessible area through the elongated spout at a rate sufficient to displace the fluid inside the non-readily accessible area; and,

e) exiting the displaced fluid through the opening on the enclosed outlet into the fluid flowing along the main stream. Steps d) and e) are repeating during the process to prevent particle deposition and fluid stagnation inside the non-readily accessible area. Another example of a non-readily accessible area is the area within the interconnection between devices.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWING

Aspects of the present invention are illustrated by way of example, and not by way of limitation, in the accompanying drawings, wherein:

FIG. 1A is a perspective view of a flush adapter in an upright position showing an open arcuate elongated spout.

FIG. 1B is a perspective view of the flush adapter of FIG. 1A tilted to show the bottom enclosed outlet.

FIG. 1C is a cross-sectional view of the flush adapter attached to a dead leg on one end and to a valve on the opposite end.

FIG. 2A is a perspective view of a flush adapter having the elongated spout attached to a ferrule for connecting the flush adapter to a non-readily accessible area having a matching ferrule.

FIG. 2B is a perspective view of the flush adapter of FIG. 2A tilted to show the bottom enclosed outlet.

FIG. 2C is a cross sectional view of the flush adapter shown in FIGS. 2A and 2B attached to a dead leg on one end and to a valve on the opposite end and showing the direction of the flow of the fluid on the dead leg relative to the main stream after attachment of the flush adapter.

FIG. 2D is a perspective view of a closed arcuate elongated spout detached from a ferrule as shown in FIGS. 2A and 2B.

FIG. 2E is a perspective view of the ferrule detached from the elongated spout.

FIG. 3A is a perspective view of the flush adapter shown in FIG. 2A with the bottom peripheral edge of the enclosed outlet attached to a second non-matching ferrule.

FIG. 3B is a perspective view of the flush adapter shown in FIG. 3A tilted to show the openings of the enclosed outlet extending to the second non-matching ferrule.

FIG. 4A is a perspective view of a flush adapter with the elongated spout extending beyond the enclosed outlet.

FIG. 4B is a perspective view of the flush adapter of FIG. 4A tilted to show the bottom of the enclosed outlet.

FIG. 4C is a cross sectional view of the flush adapter shown in FIGS. 4A and 4B attached to a dead leg on one end and to a device on the opposite end showing the enclosed outlet sandwiched between two matching ferrules.

FIG. 4D is a perspective view of the flush adapter of FIG. 4A and 4B having the enclosed outlet enveloped within a single gasket.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any means of providing a elongated arcuate device for receiving or diverting a portion of the fluid stream to flush non-readily accessible fluids out of a non-readily accessible area like a dead leg is within the scope of this invention. The detailed description includes specific details to provide a thorough understanding of the claimed invention and it is apparent to those skilled in the art that the claimed invention may be practiced without these specific details.

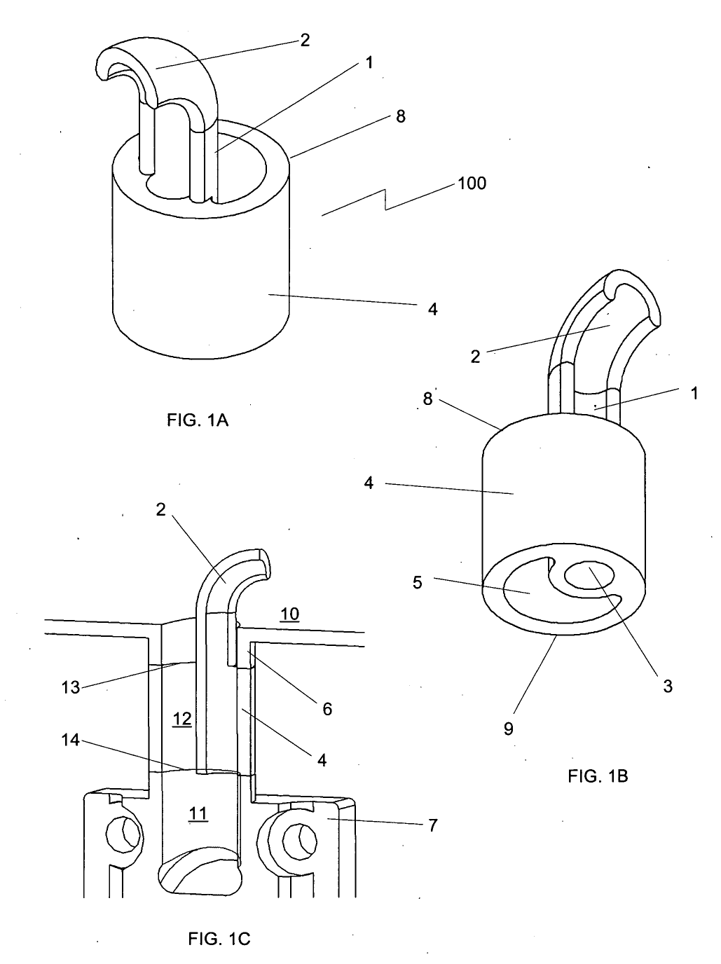

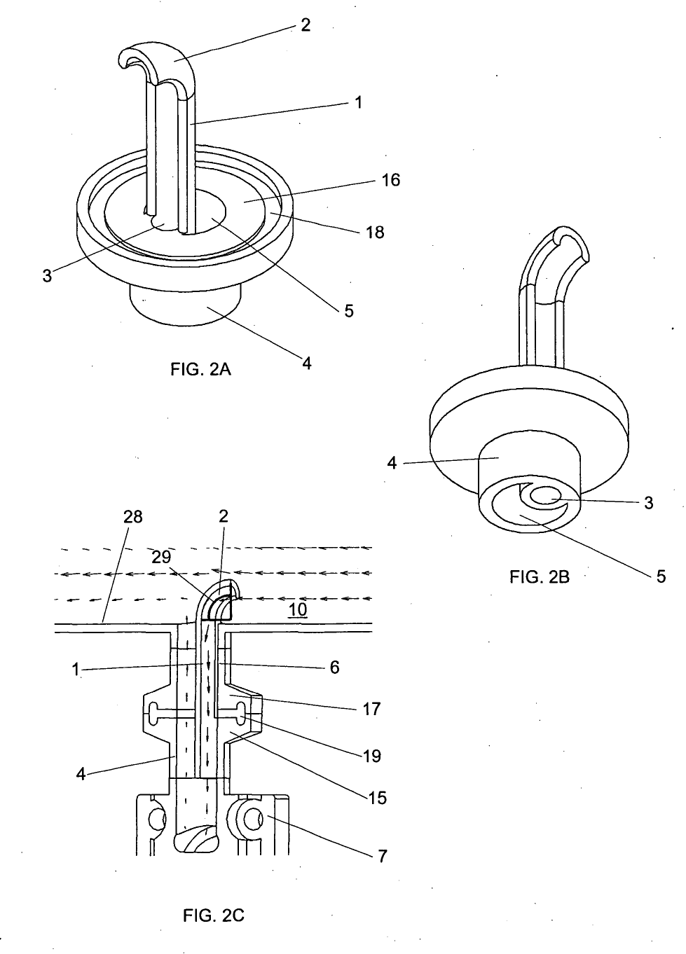

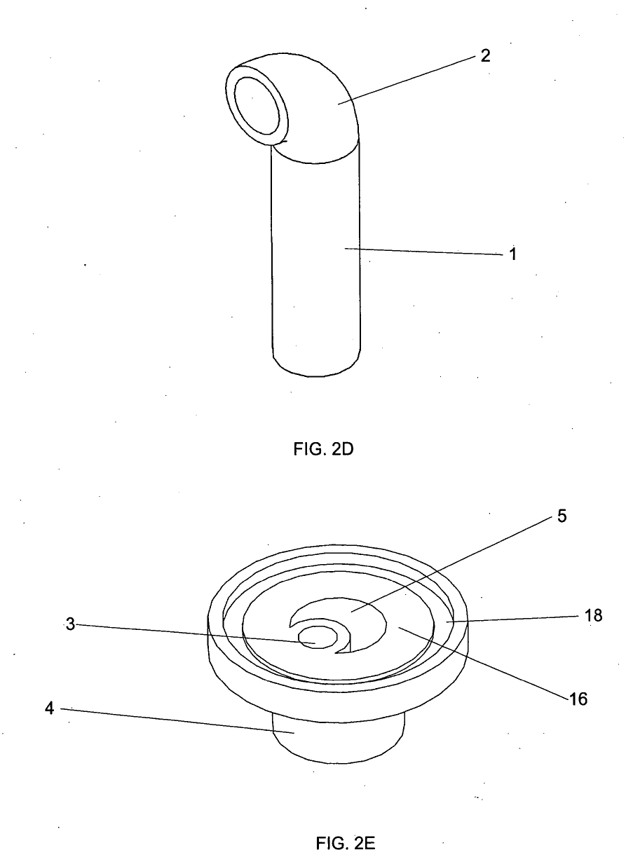

The flush adapter 100 as shown in FIGS. 1A, 2A, 3A and 4A is a device that can be connected to any fluid transport system. It is generally an elongated spout 1, recommended to be an open or a closed arcuate spout, that is, the bordering curved longitudinal walls along the elongated spout can have an angle from about 45° to a full 360° wall. The open or closed elongated spout will be referred to herein simply as elongated spout since the flush adapter can have either one. FIG. 2D shows an example of a closed arcuate elongated spout. The elongated spout 1, has a smoothly bent tip 2 on one end and terminating into a channel 3 on the other end. The channel 3, although shown here as cylindrical, can have any geometric shape so long as it allows free fluid flow. The channel 3 is enclosed within a wider enclosed outlet 4. The enclosed outlet 4 generally assumes the same geometrical shape as the channel 3. In a cylindrically shaped channel 3, the flow through opening 5 outside channel 3 is usually crescent shaped as shown in FIG. 1B. Enclosed outlet herein means a full wall around the outlet. The length or height of the enclosed outlet 4 varies according to the type of connection desired between a non-readily accessible area like a dead leg 6 and another device 7 which includes but is not limited to a valve, an equipment, a fluid outlet like a faucet, an apparatus or a test instrument. The enclosed outlet 4 may be a thick plate, a pipe or a tubing. The thick plate is usually less than two inches in thickness while the length or height of the tubing or pipe is less than the length or height of the non-readily accessible area. The elongated spout extends and protrudes from the enclosed outlet 4. The top peripheral edge 8 and the bottom peripheral edge 9 are the connecting points of the flush adapter 100 with the top peripheral edge 8 usually connecting to the non-readily accessible area like dead leg 6 and the bottom peripheral edge 9 connecting to another device 7. The flush adapter shown in FIG. 1A is the basic flush adapter without any connectors. The elongated spout 1 is inserted into the non-readily accessible area herein exemplified by the dead leg and protrudes into a conduit 10 through which the main stream of the fluid flows. The flush adapter 100 is positioned so that the bent tip faces the direction of the fluid flow as shown in FIG. 2C. Consequently, a portion of the fluid flowing along the main stream is diverted and enters the bent tip 2 facing the stream of fluid and flows downwards into the channel 3. Fluid includes liquids, gases, mixtures of solids in liquid, emulsions, suspensions, and slurries.

In a common dead leg, the fluid will either rotate or remain stagnant within the dead leg depending on the rheology of the fluid. The flush adapter 100, by having an elongated spout facing the main stream of fluid, catches a portion of the fluid and directs this fluid towards the interior of the dead leg 6 through channel 3 thereby displacing the fluid along its path. A portion of the fluid inside the dead leg 6 is carried by the fluid entering through the elongated spout 1 and exiting the channel 3. This fluid joins the fluid initially inside the dead leg and in the inlet port of a device 7 outside the fluid path of the elongated spout and the channel, identified as area 11. Because the fluid exiting channel 3 is continuous, this produces a sweeping action and carries the fluid inside area 11 upwards through the opening 5 and into a second area 12 above the opening outside of the elongated spout 1 and channel 3. This fluid flowing upwards from channel 3 through area 11 and 12 displaces any fluid or particles in these areas, flushing these upwards to rejoin the fluid flowing along the main stream. The fluid flow through the elongated spout 1 is continuous thereby preventing particle deposition or fluid stagnation inside the dead leg 6 and any other surrounding areas created through the interconnection between the flush adapter and other devices 7. It is understood that in this dead leg flushing application, the attached device is in a closed position, that is, there is no outside fluid flow through the device 7.

The flush adapter device illustrated in FIGS. 1A, 1B and 1C is usually connected by welding the top peripheral edge 8 to the dead leg bottom peripheral edge 13 and the bottom peripheral edge 9 to a peripheral edge 14 of the inlet port of a device 7. Welding followed by polishing and electropolishing is preferred for sanitary industries like the Pharmaceutical, Biochemical and Semiconductor industries. Industries that do not have stringent standards can employ any connecting means known in the art so long as leakage between the interconnecting points are avoided.

Connection by welding or permanent bonding results in permanency of the connection, herein between the conduit, the device and the flush adapter. Consequently, it removes the flexibility of removing or replacing the flush adapter from the non-readilty accessible area like dead leg 6 or from the device 7. FIGS. 2A, 2B and 2C proposes a ferrule connector on top of the top peripheral edge 8 of the flush adapter 100 for connection to a dead leg having a matching ferrule, the two ferrules secured by a clamp (not shown) after the insertion of the elongated spout 1 into the non-readily accessible dead leg 6. Ferrules are widely use in sanitary industries because they can be easily disconnected and are easily cleaned between usage. However, other sanitary connectors can be used and as stated above, other connecting means can be used for industries with less stringent standards or requirement. The ferrule 15 connects or attaches on top of the enclosed outlet 4, with the ferrule extending the opening 5 and the channel 3 as shown in FIG. 2E. In this one ferruled flush adapter shown in FIG. 2A, the elongated spout attaches to a platform 16 of the ferrule, above the channel 3 with the bent tip 2 facing away from the opening 5 as shown in FIGS. 2A and 2B. Attachments of the components of the flush adapter 100 are usually done by welding or the whole piece can be machined together. The ferrule 15 on the flush adapter shown in FIGS. 2A, 2B and 2C engages with a matching ferrule 17 on the dead leg 6. Each ferrule has a groove 18 for accommodating a gasket 19 placed between them before clamping to prevent leakage of materials at the interconnecting points as shown in FIG. 2C. Tri-clover fittings are widely used to clamp two ferrules together. In the illustration shown, the matching ferrule 17 is connected or attached to the outlet opening of a downward directed fitting, the area within which is an example of a dead leg 6. The peripheral edge 9 in this illustration is still connected or attached to a device 7 by connectors other than a ferrule.

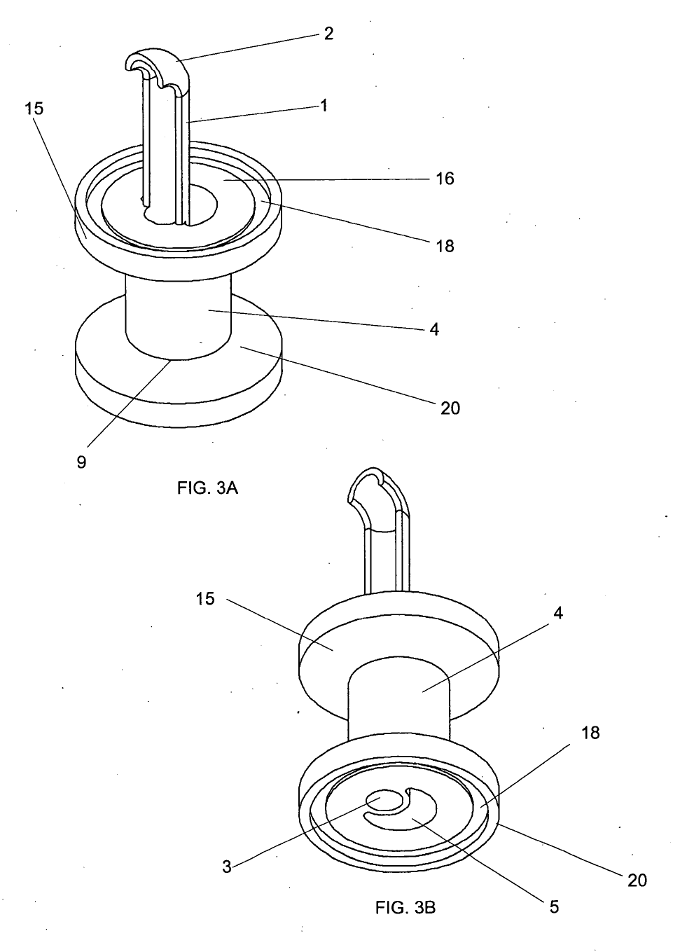

FIGS. 3A and 3B illustrates a second ferrule 20 connected or attached to the bottom peripheral edge 9 of the enclosed outlet 4. This ferrule 20 face away from ferrule 15 because it is used to connect the flush adapter 100 to other devices 7. The second ferrule 20 extends the opening 5 shown here as crescent shape, and the opening of the channel 3 as shown in FIG. 3B. Like the ferrule 15, it has a groove 18 for accommodating a gasket 19 between this ferrule 20 and another ferrule 21 (not shown) matching with ferrule 20 connected to the inlet port 22. In this type of connection, there are two sets of independent ferrule connectors clamped together by separate clamps.

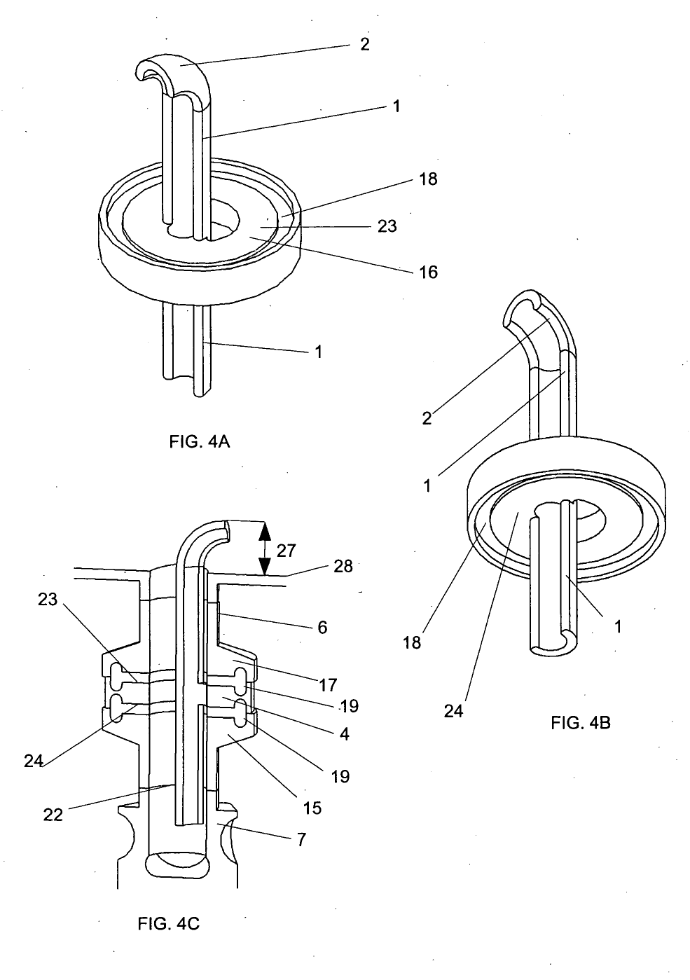

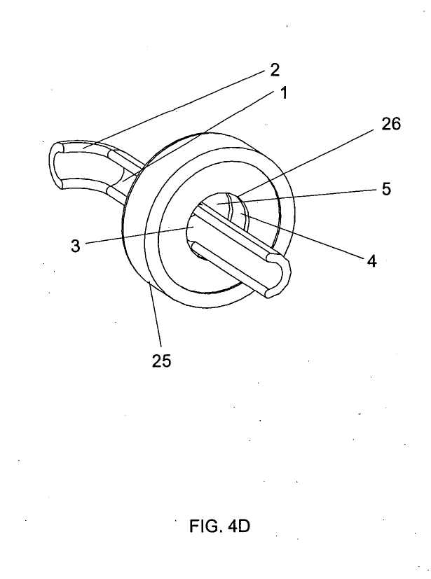

FIGS. 4A, 4B, and 4C illustrates a way of using one set of matching ferrule instead of the two sets shown in FIGS. 3A and 3B for connecting the flush adapter 100 to the dead leg 6 and to the device 7 of choice. Here, a first end of the elongated spout 1 having a bent tip protrudes both upwards from the enclosed outlet and a second end of the elongated spout 1 protrudes downwards from the enclosed outlet 4. In this example, the enclosed outlet is recommended to be a thick plate having the channel 3 and the opening 5 etched through the thick plate. Both top 23 and bottom 24 surface of the enclosed outlet 4 have a groove 18 to accommodate a gasket 19 placed between the top surface 23 of the enclosed outlet 4 and the ferrule 17 connected to the dead leg 6 and between the bottom surface 24 of the enclosed outlet 4 and the ferrule 15 connected to the inlet port 22 of the device 7 as shown in FIG. 4C. Alternately, instead of two gaskets, the enclosed outlet 4 in a form of a thick plate without the grooves, can be enveloped within a single gasket 25 having a central opening 26 exposing channel 3 attached to the elongated spout and the opening 5 as shown in FIG. 4D. The single gasket proposed here is similar but not the same as an orifice plate gasket. The bent tip end of the flush adapter 100 having the enclosed outlet 4 enveloped within a single gasket is inserted into a non-readily accessible area like a dead leg connected to ferrule 17 and the second end of the elongated spout 1 is inserted into the inlet port of the device having the matching ferrule 15. Connected and attached are used herein interchangeably. Because of the thickness of the enclosed outlet 4 (for both, one having two gaskets and another enveloped in a single gasket) between the two ferrules 15 and 17, the clamps used for securing the two matching ferrules 17 and 15, more than likely, needs to be customized for these applications.

The bent tip 2 as stated above, should be bent smoothly and at an angle that will not create any pockets or dead ends along the fluid path as the fluid traverses through a conduit. Pockets or dead ends will create the same problems encountered with dead legs. The height 27 of the bent tip 2.or the elongated spout 1 above the inner wall 28 of a conduit should be just sufficient to catch a portion of the fluid stream but not too high to cause an obstruction to the flow of the fluid. The height 27, the angle 29 of the bent tip 2, the length of the elongated spout, the radius of the elongated spout, the cross sectional dimensions of area 11 and 12, the distance of the elongated spout from the side inner walls of a non-readily accessible area dead leg are variables that depend upon the rate of flow-of the fluid, the industry process or method requirement, the dimensions of the conduit and the non-readily accessible area such as the dead leg. These variables catering to a particular application or process can be determined and optimized through actual experimentation or through Computational Fluid Dynamics (CFD) simulations. An important parameter, the rate of flow required for the redirected fluid stream entering the bent tip 2 should be such that it is capable of continuously displacing the fluid inside the non-readily accessible area and the interconnecting points as exemplified by areas 11 and 12.

The flush adapter 100 is usually independently machined before it is introduced and connected to the non-readily accessible area and to the other devices. The flush adapters with ferrule connector/s as shown in FIGS. 2A, 3A and 4A, are also usually machined together as a single piece. This flush adapter 100 can also be made by die casting for applications that will allow usage of die casted parts or components. The flush adapters especially those designed with connectors provide portability and ease of introduction not only with new fluid transport systems but also with current conduits having non-readily accessible areas like the dead legs.

In Pharmaceutical, Biochemical and Semiconductor industries, it is common to electropolish the surface of the conduit and the flush adapter especially the interconnecting points to avoid corrosion and deposition of particles on the rough surfaces. The degree of polishing and/or electropolishing needed are dependent upon the customer's specification. Further, for these industries, the device is usually made of 316 or 316L stainless steel material. Generally, the device 100 can be made of plastic, metal or composite materials depending upon the industry requirement or practice. The choice of the type of gasket is also industry driven. The direction of fluid flow, illustrated in FIG. 2C, is typical for all types of flush adapters shown here.

With these flush adapter, a dead leg can be easily used as a sampling port for testing because the fluid within is sufficiently mixed and non-stagnant. While the flush adapter drawings show a dead leg in a conduit, as stated above, the flush adapter can be used to flush out fluids as defined herein from inaccessible or non-readily accessible areas within a process flow and for other similar applications apparent from the design and functions described here.

While the embodiments of the present invention have been described, it should be understood that various changes, adaptations, and modifications may be made therein without departing from the spirit of the invention and the scope of the claims.

We claim:

1. A flush adapter, comprising:
an elongated spout having a bent tip on one end and a channel on the other end, the channel enclosed within a wider enclosed outlet, the enclosed outlet having an opening outside of the channel;
means for connecting the flush adapter to a non-readily accessible area; and,
means for connecting the flush adapter to a device.

2. The flush adapter of claim 1 wherein the enclosed outlet is of differing height or length;

3. The flush adapter of claim 2 wherein the height or length is less than the length or height of the non-readily accessible area.

4. The flush adapter of claim 1 wherein the enclosed outlet is a thick plate having the channel and the opening etched through the thick plate.

5. The flush adapter of claim 1 wherein the elongated spout is an open or a closed arcuate spout.

6. The flush adapter of claim 1 wherein the other end of the elongated spout opposite the bent tip protrudes beyond the channel enclosed within the enclosed outlet.

7. The flush adapter of claim 6 further comprising a single gasket enveloping the enclosed outlet having a central opening exposing the elongated spout extending from the channel and the opening of the enclosed outlet.

8. The flush adapter of claim 1 wherein the bent tip is smoothly bent and at an angle that will not create any pockets or dead ends along a fluid path.

9. The flush adapter of claim 1 wherein the means for connecting the flush adapter to the non-readily accessible area and to the device is a permanent connection.

10. The flush adapter of claim 1 wherein the means for connecting the flush adapter to the non-readily accessible area and to the device is a non-permanent connection.

11. The flush adapter of claim 10 wherein the non-permanent connection is a sanitary connector.

12. The flush adapter of claim 11 wherein the sanitary connector is a set of matching ferrule or a plurality of matching ferrule secured by a clamp.

13. The flush adapter of claim 12 wherein the elongated spout attaches to a platform of the ferrule connector with the bent tip facing away from the opening of the enclosed outlet.

14. The flush adapter of claim 12 wherein the elongated spout attaches to the enclosed outlet having a groove on a top and a bottom surface, the top groove accommodating a gasket from a first ferrule and the bottom groove accommodating another gasket from a second ferrule, the second ferrule matching the first ferrule.

15. The flush adapter of claim 1 wherein the means for connecting the flush adapter to the non-readily accessible area and to the device is a combination of a permanent connection and 5 a non-permanent connection.

16. The flush adapter of claim 1 wherein the non-readily accessible area is a dead leg.

17. A method for displacing fluids and particles from a non-readily accessible area with a flush adapter having an open or closed elongated spout with a bent tip on one end, held by an enclosed outlet having an opening outside of the elongated spout, comprising:
a) inserting the flush adapter into the non-readily accessible area;
b) protruding the bent tip of the flush adapter above an inner wall of a conduit connected to the non-readily accessible area;
c) positioning the bent tip to face the direction of the fluid flow ;
d) continuously diverting a portion of the fluid flow downwards into the non-readily accessible area through the elongated spout at a rate sufficient to displace the fluid inside the non-readily accessible area; and,
e) exiting the displaced fluid through the opening on the enclosed outlet into the fluid flowing along the main stream.

18. The process of claim 17 further comprising repeating steps d) and e) to prevent particle deposition and fluid stagnation inside the non-readily accessible area.

19. The process of claim 17 wherein the non-readily accessible area is a dead leg.

20. The process of claim 17 wherein the non-readily accessible area is an interconnection between devices.
